(19) United States
(12) Patent Application Publication
(10) Pub. No.: US 2015/0261986 A1
(43) Pub. Date: Sep. 17, 2015

(54) WIRELESS SEARCH

(71) Applicant: QUALCOMM Incorporated, San Diego, CA (US)

(72) Inventors: Siavash Ekbatani, San Diego, CA (US); Srinivas Chilukuri, Murrieta, CA (US)

(73) Assignee: QUALCOMM Incorporated, San Diego, CA (US)

(21) Appl. No.: 14/210,852

(22) Filed: Mar. 14, 2014

(51) Int. Cl. G06K 7/10; G08B 25/10

(52) U.S. Cl. CPC G06K 7/10366; G08B 25/10

(57) ABSTRACT

Methods, systems, and devices are described that provide for wireless searching in a location tracking environment. The methods, systems, and/or devices may include tools and techniques that provide for analyzing requests for location data of an entity and preparing a response set based on the request and the available tags. Response sets may include location data for the requested entity, location data for a second entity different from the requested entity, a clarifying question, or a null value. Multiple requests may be received and an order of evaluation will be determined. Results may be adjusted for individual users. Categories as well as individual entities may be searched. Upon receiving a response set, a mobile device may display directions to the identified entity.

### BACKGROUND

In some settings, such as indoor and enterprise environments, it may be desirable to easily locate various types of assets or people, or both. Examples of such settings include airports, hospitals, malls, grocery stores, retail stores, warehouses, etc. The accuracy and speed with which the location of entities, such as assets or people, is monitored in an indoor setting may be an important factor in determining the usefulness of a tracking system. In addition, having a location system that is cost effective, scalable, and that can provide continuous, accurate, and precise location monitoring is also desirable.

Different systems and devices may be used to locate assets and/or people in a particular indoor environment. A network such as a radio frequency network deployed throughout at least a portion of the indoor environment may be configured to perform indoor tracking. Systems may employ multiple access points (APs) placed at specific locations in the indoor environment. A location tracking tag also may be attached to each mobile asset and/or to each person to be tracked. The tag may send waveforms (e.g., beacon signals) that are received by the APs for ranging measurements to determine the distance between the tag and the APs that receive the waveforms. Once the distances between the tag and at least three different APs are obtained, triangulation or multi-lateration (e.g., trilateration) may be used to estimate the location of the asset or person to which the tag is attached. It is not always known, however, whether an entity is currently present within a particular environment. It therefore may be desirable for a system to search for an entity without knowing if the entity is present within the tracking system.

### SUMMARY

Described below are methods, systems, and devices that provide for wireless searching in a location tracking environment. Requests from a user (e.g., a mobile device) for location data of an entity may be analyzed, and a response set may be prepared based on the request and the available data from location tracking tags. Response sets may include location data for the requested entity, location data for a second entity different from the requested entity, a clarifying question, or a null value. Multiple requests may be received and an order of evaluation may be determined. Results may be adjusted for individual users. Categories as well as individual entities may be searched. Upon receiving a response set, a mobile device may display directions to the identified entity.

In some embodiments, a method for wirelessly searching an environment includes receiving, at an access point, beacons from one or more tags indicating location data for the tags, receiving, from a mobile device, a request for location data of an entity, and identifying a number of the tags that correspond to the entity.

In some embodiments, a system for wirelessly searching an environment includes means for receiving, at an access point, beacons from one or more tags indicating location data for the tags, means for receiving, from a mobile device, a request for location data of an entity, and means for identifying a number of the tags that correspond to the entity.

In some embodiments, an apparatus for wirelessly searching an environment includes a processor, memory in electronic communication with the processor, and instructions stored in the memory. The instructions may be executable by the processor to receive, at an access point, beacons from one or more tags indicating location data for the tags, receive, from a mobile device, a request for location data of an entity, and identify a number of the tags that correspond to the entity.

In some embodiments, a computer-program product for wireless searching an environment includes a non-transitory computer-readable medium storing instructions executable by a processor to receive, at an access point, beacons from one or more tags indicating location data for the tags, receive, from a mobile device, a request for location data of an entity, and identify a number of the tags that correspond to the entity.

Various embodiments of the method, system, apparatus, and/or computer-program product may include the features of, means for, and/or processor-executable instructions for determining a response set based at least in part on the request, the identified tags, a user history, a unique identification of the mobile device, or an indication from the identified tags.

Various embodiments of the method, system, apparatus, and/or computer-program product may include the features of, means for, and/or processor-executable instructions for transmitting the response set to the mobile device, and/or receiving, at an access point, a location of the mobile device. The response set may include location data of the identified tags. In some examples, the location data of the identified tags includes a relative location with respect to the location of the mobile device. Additionally or alternatively, the location data of the identified tags may include a predicted location. In some examples, the response set includes a no-match indicator, which may include at least one of a null response, a null value, an autonomous determination response, or a clarifying prompt. The response set may include data for a second entity, the second entity being different from the entity for which location data was requested.

Various embodiments of the method, system, apparatus, and/or computer-program product may include the features of, means for, and/or processor-executable instructions for updating the location data of the tags based on the received beacons.

In some embodiments of the method, system, apparatus, and/or computer-program product, receiving the request includes receiving, from the mobile device, a plurality of requests for location data of a plurality of entities, and determining an order for evaluating the plurality of requests. In some examples, determining the order for evaluating the plurality of requests is based on at least one of a proximity decision, a category decision, a sponsor decision, an advertisement decision, an availability decision, a route decision, a user history decision, an autonomous decision, or a sale decision.

In some embodiments of the method, system, apparatus, and/or computer program product, receiving the request includes receiving, from the mobile device, a category request for location data of the entity.

Further scope of the applicability of the described methods and apparatuses will become apparent from the following detailed description, claims, and drawings. The detailed description and specific examples are given by way of illustration only, since various changes and modifications within the spirit and scope of the description will become apparent to those skilled in the art.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows an example of a location tracking network in accordance with various embodiments;

FIG. 2 shows a call flow diagram that illustrates an example of wireless searching in a location tracking network in accordance with various embodiments;

FIGS. 3A and 3B show block diagrams of an example device(s) that may be employed in location tracking networks in accordance with various embodiments;

FIGS. 4A and 4B show block diagrams of an example device(s) that may be employed in location tracking networks in accordance with various embodiments;

FIG. 5 shows a block diagram of an example device that may be employed in location tracking networks in accordance with various embodiments;

FIG. 6 shows a block diagram of an example of a location tracking network in accordance with various embodiments;

FIG. 7 shows a block diagram of an example of a location tracking network in accordance with various embodiments;

FIG. 8 shows a block diagram of an example of a location tracking network in accordance with various embodiments;

FIG. 9 shows a block diagram of an example of a location tracking network in accordance with various embodiments; and

FIGS. 10 and 11 are flow diagrams that depict a method or methods of wireless searching in a location tracking network in accordance with various embodiments.

### DETAILED DESCRIPTION

The methods, systems, and/or devices may include tools and techniques that provide for varied location tracking environments. For example, it may be possible to provide a wireless hide environment, where hiding an item from a wireless search is possible by removing the association identification of that item from a searchable list. The searchability of different items may be controlled by a system administrator. Alternately, the searchability of different items may be controlled from the perspective of the tag, whether the entity attached to the tag desires to be searchable or not. A system administrator may be able to prevent a search, or searches, and make some or all tags inaccessible to a user, or group of users.

In some cases, a wireless access environment is possible where different entities can give access to different users. For example, different categories of entities may be subject to a search by different user groups. Further, different user groups may have different priorities for searching, such as allowing some user groups to search while other user groups are temporarily prevented from searching.

A wireless categorization environment may be possible, allowing categories of items to be searched. In a military application, for example, “sergeants” may be searched instead of a particular sergeant, such as “Sergeant John.” Additionally or alternatively, the search category of entities may be changed by a system administrator. For example, a commander may assign Sergeant John and Sergeant Vince to the category of sergeants searchable by generals.

In some cases, a wireless advertisement environment is possible. In some embodiments, an indoor tracking device may be provided by a representative of the environment, and upon searching for a specific entity other entities in the same category or location may be displayed. For example, if a user searches for a particular type and brand of makeup, the device may advertise competing products with similar pricing.

In some cases, wireless invisibility in an environment is possible, such as an entity that may be visible when it recognizes the requesting device or a group of requesting devices. Alternately, the entity may hide from a search when recognizing the requesting device or a group of requesting devices.

Actions may be triggered based on a wireless search in some environments. For example, a traffic light or smart gate may open or close, or take other action, when a requesting device is recognized and/or within a predetermined range. Alternate actions are possible based on different categories of users, or user groups. In some environments, it is possible to predict the future trajectory of a tag by analyzing its previous locations.

A wireless phantom search environment may be possible. The system may enable searching a characteristic of the entity that changes over time. Further, an administrator may determine what users searched on for an entity. In some cases, the administrator may change the characteristic and search ability of the entity, such as by decreasing the visibility of the entity or ordering more of the entity. A search for searched items may be performed. In some cases, a search characteristic of the entity may change, such as after every search. At times, entities may be included in the search results even if they are not currently present in the environment. A system administrator may have access to a history of entities or searches.

Thus, the following description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

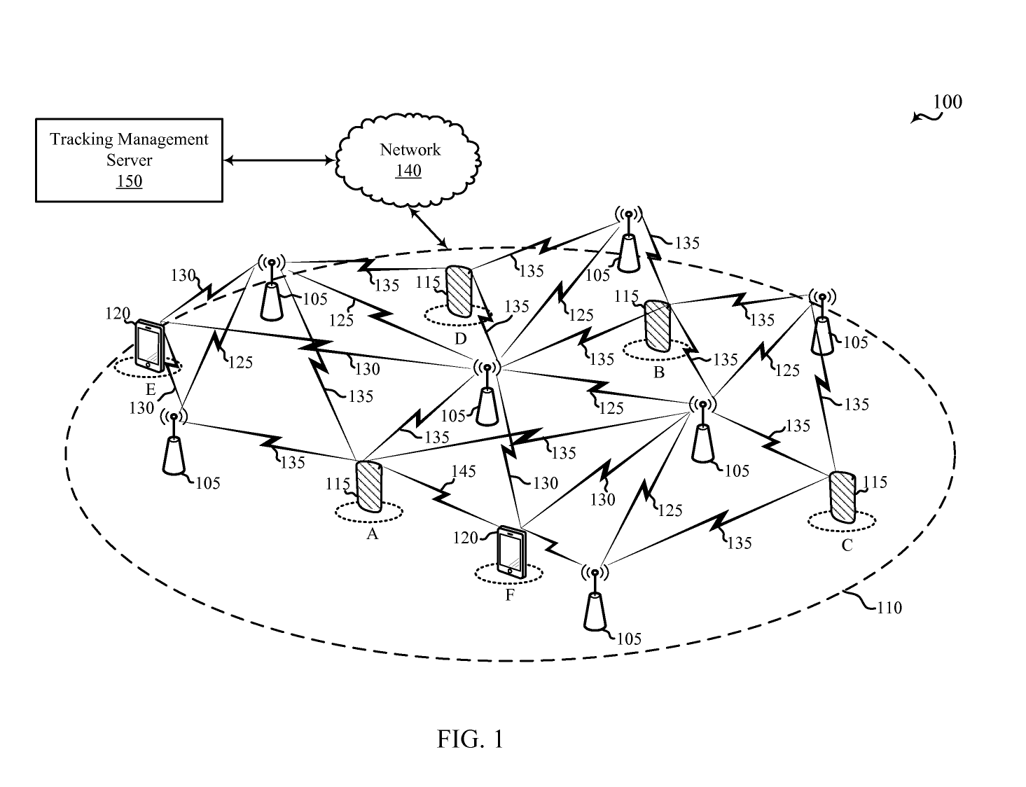

FIG. 1 depicts an example of a location tracking system 100 in accordance with various embodiments. The system 100 provides location tracking of entities, including assets (e.g., objects) or people, or both, throughout the coverage area 110. In some cases, the coverage area 110 is associated with an indoor and/or enterprise environment. In some embodiments, the coverage area 110 represents an area of coverage inside a building, such as a museum, a hospital, an airport, a retail store, a department store, a factory, a silo or a warehouse. Within the coverage area 110, multiple APs 105 may be deployed at specific locations, as may multiple tags 115 (also referred to as tag units and location tracking tags), which may be tracked within the coverage area 110. Further, multiple mobile devices 120 may be present within the coverage area 110. Because of their stationary nature, the exact distance between any two APs 105 is typically known, or may be determined, throughout the operation of the system 100. Any two APs 105 may ascertain the distance between themselves through a ranging operation, which may be a two-way ranging operation. The ranging operation may be performed via communication links 125.

The arrangement of APs 105 shown in FIG. 1 is intended as a non-limiting example. The APs 105 may be deployed or distributed within the coverage area 110 in a manner or pattern different from that depicted in FIG. 1. For example, the APs 105 may be arranged at different distances from one another. In some cases, the coverage area 110 represents a two-dimensional deployment, such as a single floor within a building. But in some embodiments, the APs 105 are deployed in a three-dimensional manner by placing some of the APs 105 on different floors or levels of a building within the coverage area 110.

Each of the APs 105 may be equipped with one or more oscillators or timers, or both. The oscillators may each produce a repetitive, oscillating electronic signal, which may be adjustable and/or variable. The oscillators may be radio frequency (RF) oscillators. The oscillators may be linear- or relaxation-type. In some embodiments, the oscillators are voltage controlled, temperature compensated crystal oscillators (VCTCXO). The timers may include quartz clock(s), they may be digital, and/or they may be implemented in software.

Each of the tag units 115 may be attached to an asset or a person being tracked within the coverage area 110. The tag units 115 may be equipped with a narrowband transceiver or a UWB transmitter, or both. The tag units 115 may also have one or more oscillators or timers, or both. The oscillators may each produce a repetitive, oscillating electronic signal, which may be adjustable and/or variable. The oscillators may be RF oscillators. The oscillators may be linear- or relaxation-type. By way of example, the oscillators are VCTCXO. The timers may include quartz clock(s), they may be digital, and/or they may be implemented in software. Those skilled in the art will recognize that the tools and techniques described herein may be implemented with oscillators of varying frequency, and timers of varying clock speeds.

FIG. 1 depicts an example location tracking system 100 with four tag units 115 at locations A, B, C, and D. In the depicted example location tracking system 100, two mobile devices 120 are present at locations E and F. Over time, these locations may change as the assets or people to which the tags 115 and/or mobile devices 120 are attached move or are moved within the coverage area 110. The system 100, shown with four tags 115 and two mobile devices 120, is intended as a non-limiting example of a location tracking system. Those skilled in the art will recognize that the system 100 is scalable, and it may be capable of tracking more or fewer assets or people as well as being accessed by more or fewer mobile devices.

The system 100 may include a tracking management server 150, which also may be referred to as a tag tracking management server or a location tracking server. In some embodiments, the tracking management server 150 is connected to the APs 105 through a network 140. The connection may be by way of a radio network associated with the APs 105. In some cases, the location tracking server 150 is a part of one or more APs 105. The tracking management server 150 may receive information from the APs 105 to perform various types of calculations, including: identifying a number of tags that correspond to a request, determining a response set, storing the location of the tags, updating the location of the tags, determining an order for evaluating a plurality of requests, or various decision operations.

The APs 105 may communicate with one another by sending and/or receiving signals, such as through communication links 125. In some embodiments, APs 105 communicate using a WiFi mesh network. Transmissions or broadcasts between APs 105 and tags 115 may occur via communication links 135, and transmissions or broadcasts between mobile devices 120 and APs may occur via communication links 130. In some cases, the mobile devices 120 may communicate or receive signals from tags 115 via communication links 145.

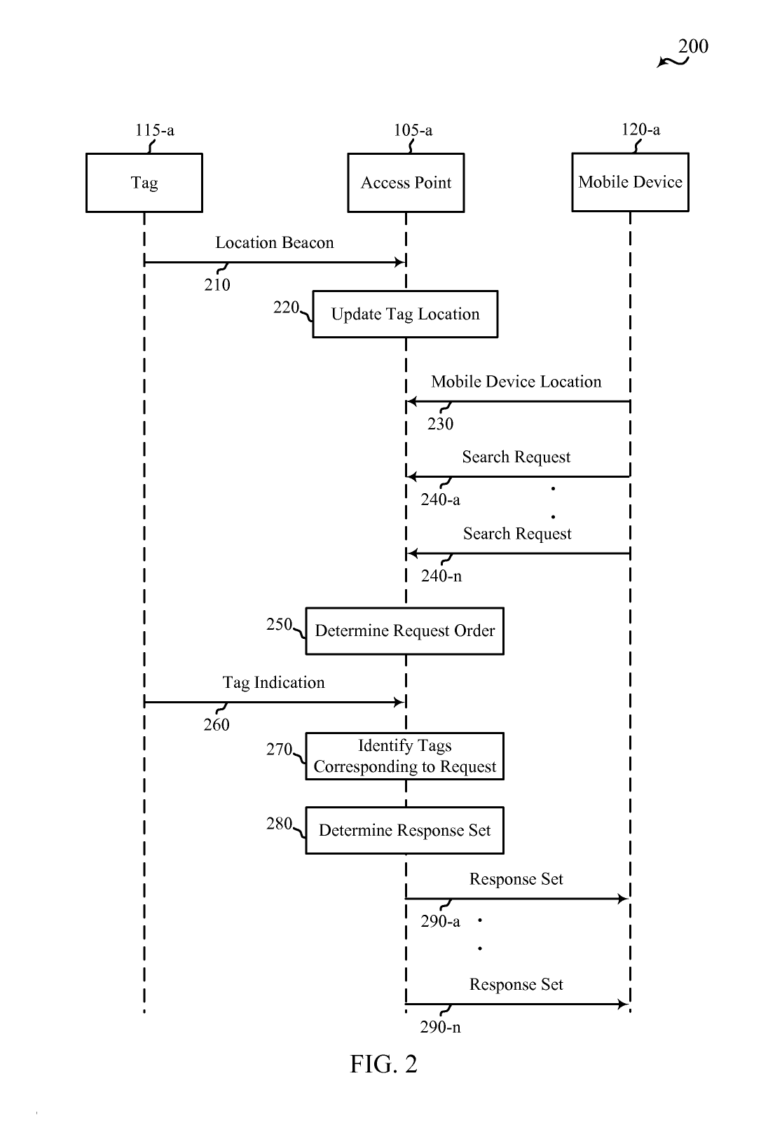

FIG. 2 shows a call-flow diagram 200, which illustrates, according to some embodiments, communication with a system configured for wirelessly searching in a coverage area of an environment. FIG. 2 shows communications between a tag 115-a, an access point 105-a, and a mobile device 120-a. While only a single tag 115-a, a single access point 105-a, and a single mobile device 120-a are shown, it should be appreciated that more or fewer tags 115, access points 105, and/or mobile devices 120 may communicate in the system. The tag 115-a, access point 105-a, and mobile device 120-a may be examples of the tag 115, access point 105, and mobile device 120 of FIG. 1.

A location beacon 210 may be transmitted from the tag 115-a and received by the access point 105-a. The location beacon 210 may include information relating to the location of the tag 115-a. In some cases, the location beacon 210 includes a signal, such as a reference signal, that may be used by one or more access points 105, such as the access point 105-a, to determine the tag's 105-a location, such as through trilateration or multi-lateration. The access point 105-a may update 220, or prompt an update of, a location of the tag 115-a. For example, the access point 105-a may update previously stored location data. In some cases, the stored location is stored in a database, such as a database that is a part of the location tracking server 150. The access point 105-a may receive a location 230 of the mobile device 120-a. The location may be GPS coordinates, network location data, or the like. Additionally or alternatively, the access point 105-a may receive information from the mobile device 120-a which allows the access point 105-a, or a plurality of access points 105, to determine the location of the mobile device 120-a. In some cases, the access point 105-a also receives information relating to the mobile device 120-a, such as a unique identification of the mobile device 120-a or the user.

The mobile device 120-a may send a request 240, or a plurality of requests 240-a through 240-n, to the access point 105-a. The request 240 may be a request for location data, such as for an entity or a plurality of entities. In some cases, the request is a category request for location data of a category of entities. As an example, in a grocery store environment, a category of entities may be “vegetables,” or “deodorant,” whereas an entity might be “a cucumber,” “AA batteries,” or “Coca-Cola®.” If a plurality of requests 240-a through 240-n were received, it may be necessary to determine an order 250 to evaluate the requests. Determining a request order 250 may be based at least in part on a number of different decisions. In some cases, a proximity decision may be used, such as determining an order based on the distance of the entity from the mobile device 120-a. For example, in a store environment a proximity decision may be used to direct the user to the closest requested entity, before moving on to the next closest entity. Alternately, a proximity decision may direct a user towards an area that is dense with requested entities.

Further, a category decision may be used to determine a request order 250. A category decision may group entities by category. For example, in a shopping mall environment, a category decision may direct a user towards entities that are available in the same store before progressing to another store. A sponsor decision may be used to determine a request order 250. A sponsored entity may have an elevated priority and be evaluated before other entities. An advertisement decision may be used to determine a request order 250. For example, an advertising entity may be evaluated periodically, such as once for every three requested entities evaluated. Further, an availability decision may be used to determine a request order 250. In some cases, entities with low, or no, availability may be evaluated after entities that are available. Additionally, entities with high availability may be evaluated before entities with lower availability. Conversely, entities with low availability may be evaluated before entities with high availability (e.g., in an effort to prevent entities with low availability from being exhausted). Further, entities that are only temporarily available may be prioritized over entities that are considered generally available.

A route decision may be used to determine a request order 250. A route decision may evaluate requests in a manner that directs a user on an efficient route, such as the shortest route, while evaluating requests. Further, a user history decision may be used to determine a request order 250. A user history may be linked with a user identification and/or a unique identification of a mobile device 120-a. For example, if a user has shown a brand preference, or a preference for some stores over others, those requests may be evaluated with a higher priority than other requests. Further, a user may prioritize some entities over others, which may influence the request order 250.

In some embodiments, an autonomous decision is used to determine a request order 250. For example, in a hardware store environment, if a user searches “glue,” an autonomous decision may direct a user towards wood glue rather than a glue stick more commonly used for school or office tasks based on the type of store. In some cases, an autonomous decision is based on other factors—for instance, routing a user to frozen goods last to prevent thawing in a grocery store environment. A sale decision may be used to determine a request order 250. A sale decision may use a temporary designation, such as an entity that is on sale, when determining a request order 250. For example, entities that are currently on sale may be prioritized over regularly priced entities. It should be noted that a plurality of decisions may be used, in any order, while determining a request order 250.

In some embodiments, an indication is sent 260 from the tag 115-a to the AP 105-a. The indication 260 may represent a state of the tag 115-a. The indication 260 may be a binary value such as the tag is available for tracking services, or not available for tracking services. The indication 260 may have more than two values as well, such as representing a number of available entities, representing an emotional mood of a tagged employee, representing the current activity (e.g., moving or stationary) of the tag, etc. For example, in a retail store environment, a request may be made for the location of a store manager. An indication 260 may show some managers as currently helping other customers, a number of customers currently in the manager's queue, a manager that is on break, or a manager that is currently available. It should be noted that the indication may prevent the tracking system from, or authorize the system to, track the tag 115-a; or the indication may prevent the system from, or authorize the system to, include the tag in a response to the mobile device 120-a. In some cases, a system administrator may make everything, or some entities, inaccessible to a user, or group of users.

The AP 105-a may identify 270 a number of the tags 115 that correspond to the entity. For example, if the request 240 was for a store manager and there is a single store manager which is associated with the tag 115-a, then the AP 105-a may identify 270 the tag 115-a as corresponding to the requested entity. Further, the AP 105-a may use any number of decisions, such as those described above relating to determining the request order 250, when identifying 270 tags that correspond to the requested entity. In some cases, there are multiple tags 115 that correspond to the requested entity. In some cases, there are no tags 115 that correspond to the requested entity.

The AP 105-a may determine a response set 280. In some cases, determining a response set 280 is based on the request. For example, a response set may include all of the tags 115 that correspond to the requested entity. Determining the response set 280 may be based on the identified tags. For example, a set of identified tags may be reduced through decisions, such as those described above in regard to determining the request order 250. Determining the response set 280 may be based on a user history. For example, if a user has a history of searching for wheelchair-accessible restrooms while at the airport, a set of identified restrooms may be reduced to only restrooms with wheelchair accessibility. Determining the response set 280 may be based on a history of users. For example, a response set 280 may be based on what items are most popular, such as what a plurality of users, or a subset of a plurality of users, have previously searched.

Determining the response set 280 may be based on a unique identification of the mobile device 120-a. In some cases, the unique identification of the mobile device 120-a is associated with a user. The unique identification of the mobile device 120-a may be used to determine if the mobile device 120-a is authorized for the search. The unique identification of the mobile device 120-a may be authorized for all requests, some requests, or no requests. For example, a unique identification of the mobile device 120-a may signal to the AP 105-a that the user is under the legal age to purchase a weapon, such as a gun. In this example, a request from the mobile device 120-a for the location of a gun may result in a response set including the location of a toy gun, rather than a real gun; or it may include a null response set, as discussed below, indicating that nothing was found or that no responsive data was found. Determining the response set 280 may be based on an indication from the identified tags, as described above in relation to receiving the tag indication 260.

The AP 105-a may send (e.g., transmit) the determined response set 290 to the mobile device 120-a. In some cases, the AP 105-a sends multiple response sets 290-a through 290-n to the mobile device 120-a. The number of response sets sent 290-a through 290-n may be equal to the number of requests received 240-a through 240-n, or different from the number of requests received 240-a through 240-n. The response set 290 may include location data of the identified tag(s). In some cases, the location data of the identified tag(s) includes a history of the location of the identified tag(s). The location data of the identified tags may include a predicted location of the identified tag(s). The predicted location may be based on a history of locations of the identified tag(s).

In some cases, the response set 290 includes a no-match indicator. A no-match indicator may be a null response, a response containing a null value, an autonomous determination response, or a clarifying prompt. An autonomous determination response may include location data for a subset of identified tags, the subset being determined such as by a decision similar to those discussed above in reference to determining a request order 250. In some cases, the response set 290 includes a clarifying prompt, such as a question that will reduce the identified tags. For example, in an airport environment, if a mobile device 120-a requests a location for a restroom, the response set may include a clarifying prompt asking the user if they are looking for a men's restroom, a women's restroom, a family-friendly restroom, or any of the above. The response from the mobile device 120-a to the clarifying prompt may be used by the AP 105-a to determine a result set. In some cases, the response set may include data for a second entity. The second entity may be different from the requested entity. For example, in an airport environment, if a mobile device 120-a requests the location of a police officer, the response set may include location data for a firefighter, or other emergency personnel.

It should be noted that in some embodiments, the AP 105-a represents, or is interchangeable with, a location tracking server 150. In some cases, the AP 105-a interacts with a location tracking server 150 during some or all of the above mentioned steps.

Those skilled in the art will recognize that the system and the call flow described above is but one implementation of the tools and techniques discussed herein. The operations, or parts of operations, of the call flow may be rearranged or otherwise modified such that other implementations are possible. Further, all of the operations of the system may be performed, or only some of the operations of the system may be performed. In some cases, an operation of the system may be performed numerous times.

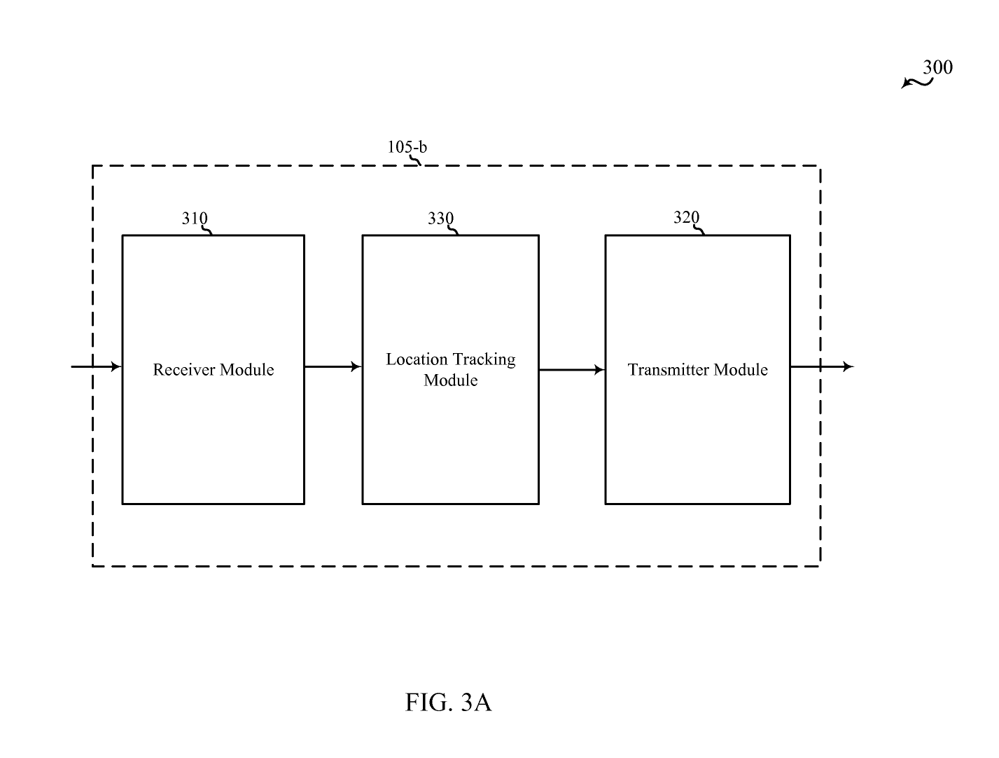

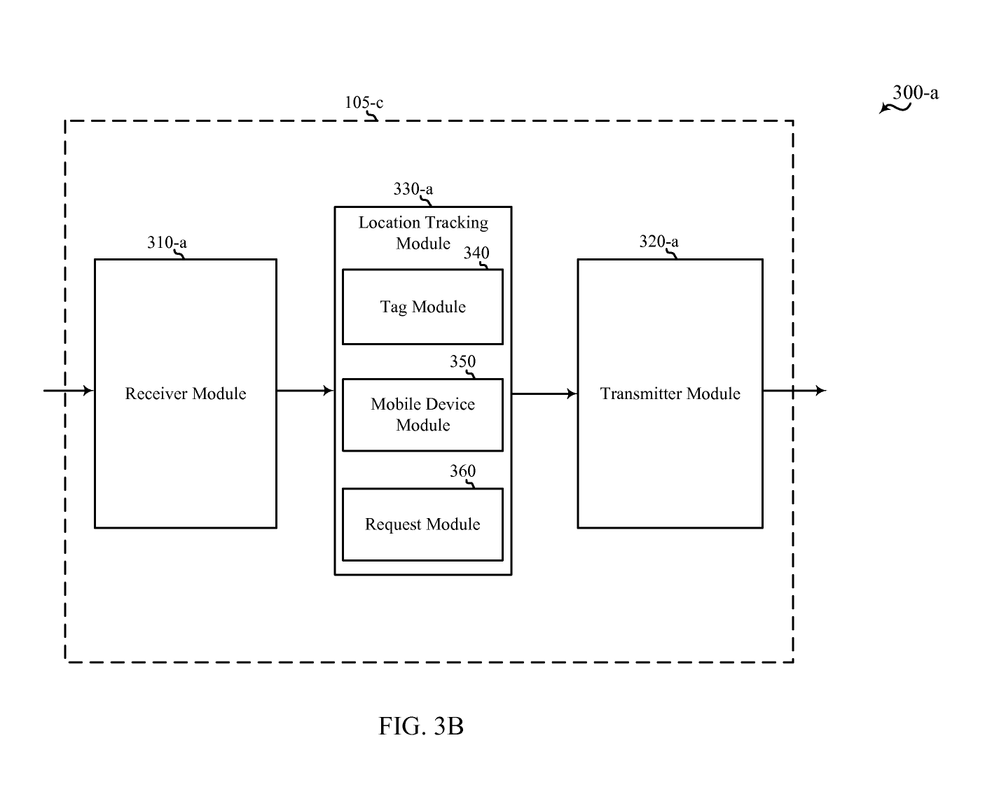

FIG. 3A shows a block diagram illustrating a device 300 configured for wirelessly searching in a location tracking environment in accordance with various embodiments. The device 300 may be an AP 105-b, which may be an example of an AP 105 of FIG. 1, an AP 105-a of FIG. 2, or both. In some embodiments, the device 300 is a processor. The device 300 may include a receiver module 310, a location tracking module 330, and/or a transmitter module 320. In some cases, the receiver module 310 and the transmitter module 320 are a single, or multiple, transceiver module(s). The receiver module 310 and/or the transmitter module 320 may include an integrated processor; they may also include an oscillator and/or a timer. The receiver module 310 may receive signals from tags 115, mobile devices 120, other APs 105, and/or a location tracking server 150. The receiver module 310 may perform operations, or parts of operations, of the system and call flow described above in FIG. 2, including receiving a tag location beacon 210, receiving a mobile device location 230, receiving a request 240, and/or receiving a tag indication 260. The transmitter module 320 may transmit signals to tags 115, mobile devices 120, other APs 105, and/or a location tracking server 150. The transmitter module 320 may perform operations, or parts of operations, of the system and call flow described above in FIG. 2, such as sending a response set 290.

The device 300 may include a location tracking module 330. The location tracking module 330 may include an integrated processor. The location tracking module 330 may track the location of tags 115 and/or analyze signals received from tags 115. The location tracking module 330 may analyze information relating to and/or received from a mobile device 120. Further, the location tracking module 330 may evaluate requests as well as determine an order for evaluating requests. The location tracking module 330 may include a database. The database may store information relating to tags 115, mobile devices 120, users, and/or requests.

By way of illustration, the device 300, through the receiver module 310, the location tracking module 330, and the transmitter module 320, may perform operations, or parts of operations, of the system and call flow as described above with reference to FIG. 2, including updating a tag location 220, determining a request order 250, identifying corresponding tags 270, and determining a response set 280.

FIG. 3B shows a block diagram of a device 300-a configured for wirelessly searching in a location tracking environment in accordance with various embodiments. The device 300-a may be an example of the device 300 of FIG. 3A; and the device 300-a may perform the same or similar functions as described above for device 300. In some embodiments, the device 300-a is an AP 105-c, which may include one or more aspects of the APs 105 described above with reference to any or all of FIGS. 1, 2, and 3A. The device 300-a may also be a processor. In some cases, the device 300-a includes a receiver module 310-a, which may be an example of the receiver module 310 of FIG. 3A; and the receiver module 310-a may perform the same or similar functions as described above for receiver module 310. In some cases, the device 300-a includes a transmitter module 320-a, which may be an example of the transmitter module 320 of FIG. 3A; and the transmitter module 320-a may perform the same or similar functions as described above for transmitter module 320.

In some embodiments, the device 300-a includes a location tracking module 330-a, which may be an example of the location tracking module 330 of FIG. 3A. The location tracking module 330-a may include a tag module 340. The tag module 340 may perform operations, or parts of operations, of the system and call flow described above in FIG. 2, such as analyzing a tag location beacon 210, updating a tag location 220, analyze a tag indication 260, and/or identifying tags that correspond to a request 270.

In some cases, the device 300-a includes a mobile device module 350. The mobile device module 350 may perform operations, or parts of operations, of the system and call flow described above in FIG. 2, such as analyzing a mobile device location 230, analyzing a request 240, and/or preparing a response set 290.

In some cases, the device 300-a includes a request module 360. The request module 360 may perform operations, or parts of operations, of the system and call flow described above in FIG. 2, such as analyzing a request 240, determining a request order 250, identifying tags that correspond to a request 270, determining a response set 280, and/or preparing a response set 290.

According to some embodiments, the components of the devices 300 and/or 300-a are, individually or collectively, implemented with one or more ASICs adapted to perform some or all of the applicable functions in hardware. In other embodiments, the functions of device 300 and/or 300-a are performed by one or more processing units (or cores), on one or more integrated circuits. In other embodiments, other types of integrated circuits are used (e.g., Structured/Platform ASICs, FPGAs, and other Semi-Custom ICs), which may be programmed in any manner known in the art. The functions of each unit may also be implemented, in whole or in part, with instructions embodied in a memory, formatted to be executed by one or more general or application-specific processors.

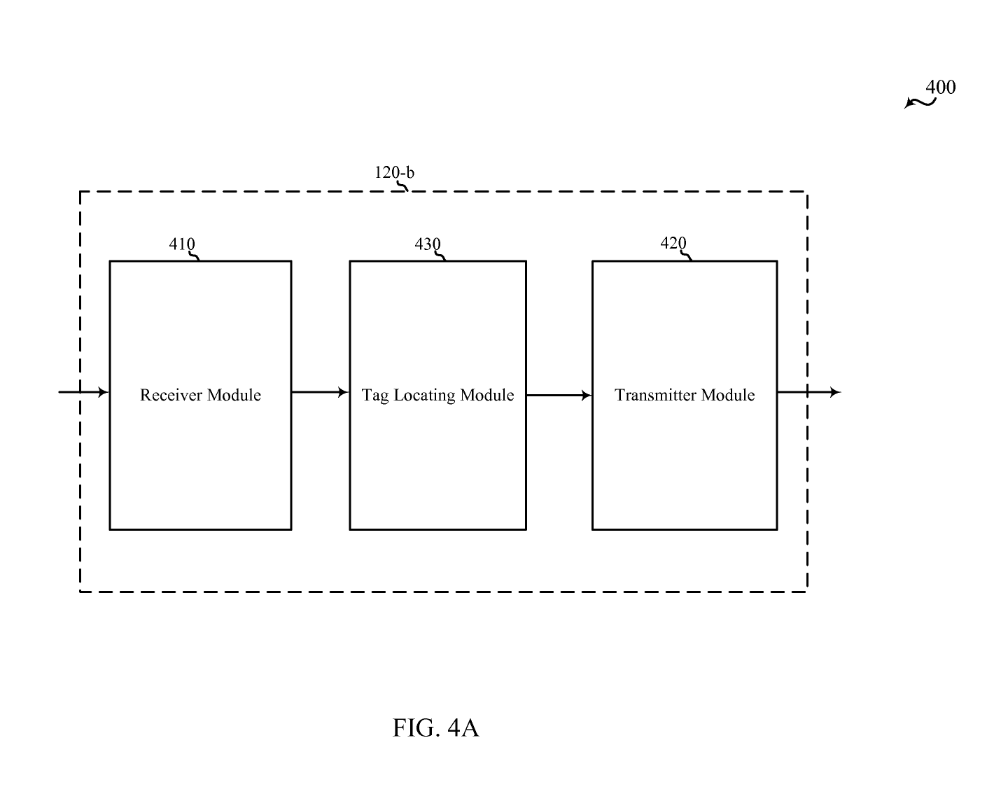

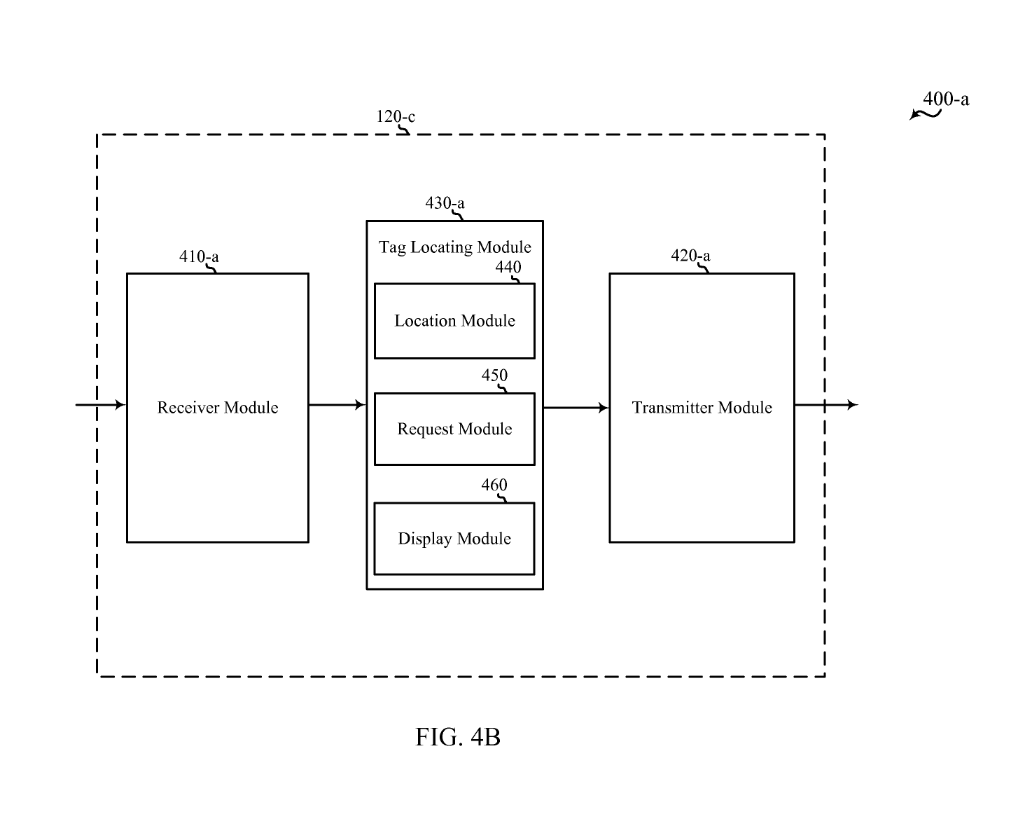

FIG. 4A shows a block diagram illustrating a device 400 configured for wirelessly searching in a location tracking environment in accordance with various embodiments. The device 400 may be a mobile device 120-b, which may be an example of a mobile device 120 of FIG. 1, a mobile device 120-a of FIG. 2, or both. In some embodiments, the device 400 is a processor. The device 400 may include a receiver module 410, a tag locating module 430, and/or a transmitter module 420. In some cases, the receiver module 410 and the transmitter module 420 are a single, or multiple, transceiver module(s). The receiver module 410 and/or the transmitter module 420 may include an integrated processor. They may also include an oscillator and/or a timer. The receiver module 410 may receive signals from tags 115, other mobile devices 120, APs 105, and/or a location tracking server 150. The receiver module 410 may perform operations, or parts of operations, of the system and call flow as described above with reference to FIG. 2, such as receiving a response set 290. The transmitter module 420 may transmit signals to tags 115, other mobile devices 120, APs 105, and/or a location tracking server 150. The transmitter module 420 may perform operations, or parts of operations, of the system and call flow as described above with reference to FIG. 2, such as sending a mobile device location 230, and/or sending a request 240.

The device 400 may include a tag locating module 430. The tag locating module 430 may include an integrated processor. The tag locating module 430 may determine a location of the mobile device 120-b. In some cases, the tag locating module 430 prepares a request. The tag locating module 430 may display information received from an AP 105.

By way of illustration, the device 400, through the receiver module 410, the tag locating module 430, and the transmitter module 320, may perform operations, or parts of operations, of the system and call flow as described above with reference to FIG. 2, including preparing and/or transmitting a location 230 of the mobile device 120-b, preparing and/or transmitting a search request 240, and receiving and/or analyzing a response set 290. In some cases, the device 400 may display information received from an AP 105.

FIG. 4B shows a block diagram of a device 400-a configured for wirelessly searching in a location tracking environment in accordance with various embodiments. The device 400-a may be an example of the device 400 of FIG. 4A; and the device 400-a may perform the same or similar functions as described above for device 400. In some embodiments, the device 400-a is a mobile device 120-c, which may include one or more aspects of the mobile devices 120 described above with reference to any or all of FIGS. 1, 2, and 4A. The device 400-a may also be a processor. In some cases, the device 400-a includes a receiver module 410-a, which may be an example of the receiver module 410 of FIG. 4A; and the receiver module 410-a may perform the same or similar functions as described above for receiver module 410. In some cases, the device 400-a includes a transmitter module 420-a, which may be an example of the transmitter module 420 of FIG. 4A; and the transmitter module 420-a may perform the same or similar functions as described above for transmitter module 420.

In some embodiments, the device 400-a includes a tag locating module 430-a, which may be an example of the tag locating module 430 of FIG. 4A. The tag locating module 430-a may include a location module 440. The location module 440 may perform operations, or parts of operations, of the system and call flow described above with reference to FIG. 2, such as preparing a location of the mobile device 120-c and/or preparing a unique identification of the mobile device 120-c.

In some cases, the device 400-a includes a request module 450. The request module 450 may perform operations, or parts of operations, of the system and call flow described above with reference to FIG. 2, such as preparing a request 240 and/or analyzing a response set 290.

In some cases, the device 400-a includes a display module 460. The display module 460 may perform operations, or parts of operations, of the system and call flow described above with reference to FIG. 2, such as analyzing a response set 290. In some cases the display module 460 may display location data received from an AP 105, such as location data included in a response set 290. In some embodiments, the display module 460 displays location data for an identified tag and/or a requested entity. For example, in a grocery store environment the display module may display location data, such as but not limited to, an aisle, a side of the aisle, and/or a location within an aisle for an identified tag 115. In some cases, the display module 460 displays a history of location data for an identified tag 115, such as a number of previous locations. In some embodiments, the display module 460 displays a predicted location for an identified tag 115.

The display module 460 may display a relative location, such as with respect to the location of the mobile device. For example, the display module 460 may display a direction indicator, such as an arrow, and/or a distance indicator, such as the magnitude of the arrow. In some cases, the display module 460 displays an arrow indicative of the direction the identified tag 115 is with respect to the location of the mobile device. In some embodiments, the display module 460 displays an arrow indicative of the direction of motion needed to reach the identified tag 115 with respect to the location of the mobile device and based on other input, such as known obstructions. The display module 460 may display an arrow with a limited set of directions, such as forward, backward, left, right, diagonally forward or backward to the left, and diagonally forward or backward to the right. In some embodiments, the display module 460 displays a proximity indicator to indicate to the user that the identified tag 115 is within a certain proximity, such as a predetermined range. In some cases, the display module 460 displays a relative location, such as with respect to a known landmark. In some embodiments, the display module 460 overlays the location data for the identified tag 115 over another image and/or display, such as a map of the area. The display module 460 may periodically update the displayed location to account for movement of the identified tag 115 and/or the mobile device 120-c. In an embodiment, the display module 460 displays the location of the mobile device 120-c and at least one identified tag 115.

In some embodiments, the components of the device 400 and/or 400-a are, individually or collectively, implemented with one or more application-specific integrated circuits (ASICs) adapted to perform some or all of the applicable functions in hardware. Alternatively, the functions may be performed by one or more processing units (or cores), on one or more integrated circuits. In other embodiments, other types of integrated circuits are used (e.g., Structured/Platform ASICs, field-programmable gate arrays (FPGAs), and other Semi-Custom integrated circuits (ICs)), which may be programmed in any manner known in the art. The functions of each unit also may be wholly or partially implemented with instructions embodied in a memory, formatted to be executed by one or more general or application-specific processors.

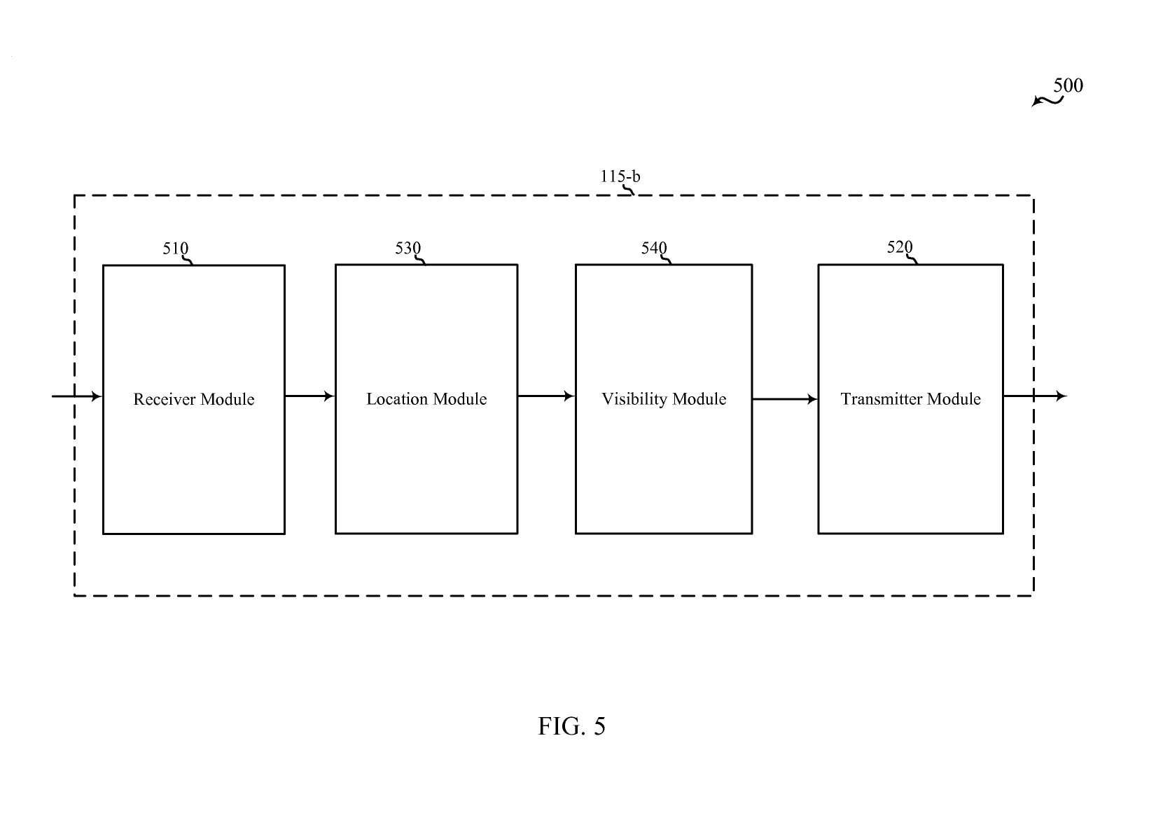

FIG. 5 shows a block diagram illustrating a device 500 configured for wirelessly searching in a location tracking environment in accordance with various embodiments. The device 500 may be a tag 115-b, which may be an example of a tag 115 of FIG. 1, a tag 115-a of FIG. 2, or both. In some embodiments, the device 500 is a processor. The device 500 may include a receiver module 510, a location module 530, a visibility module 540, and/or a transmitter module 520. In some cases, the receiver module 510 and the transmitter module 520 are a single, or multiple, transceiver module(s). The receiver module 510 and/or the transmitter module 520 may include an integrated processor. They may also include an oscillator and/or a timer. The receiver module 510 may receive signals from other tags 115, mobile devices 120, APs 105, and/or a location tracking server 150. The receiver module 510 may perform operations, or parts of operations, of the system and call flow as described above with reference to FIG. 2, such as receiving a request for a location beacon 210. The transmitter module 520 may transmit signals to other tags 115, mobile devices 120, APs 105, and/or a location tracking server 150. The transmitter module 520 may perform operations, or parts of operations, of the system and call flow as described above with reference to FIG. 2, such as sending a location beacon 210 and/or sending a tag indication 260.

The device 500 may include a location module 530. The location module 530 may include an integrated processor. The location module 530 may determine a location of the tag 115-b. The location module 530 may prepare a signal that may be used to determine a location of the tag 115-b such as a reference signal. The location module 530 may analyze a request for a location beacon.

The device 500 may include a visibility module 540. The visibility module 540 may include an integrated processor. The visibility module 540 may perform operations, or parts of operations, of the system and call flow described above with reference to FIG. 2, such as preparing a tag indication 260.

In some embodiments, the components of the device 500 are, individually or collectively, implemented with one or more application-specific integrated circuits (ASICs) adapted to perform some or all of the applicable functions in hardware. Alternatively, the functions may be performed by one or more processing units (or cores), on one or more integrated circuits. In other embodiments, other types of integrated circuits are used (e.g., Structured/Platform ASICs, field-programmable gate arrays (FPGAs), and other Semi-Custom integrated circuits (ICs)), which may be programmed in any manner known in the art. The functions of each unit also may be wholly or partially implemented with instructions embodied in a memory, formatted to be executed by one or more general or application-specific processors.

By way of illustration, the device 500, through the receiver module 510, the location module 530, the visibility module 540, and the transmitter module 520, may perform operations, or parts of operations, of the system and call flow as described above with reference to FIG. 2, such as but not limited to receiving and/or analyzing a request for a location beacon 210, preparing and/or transmitting a location beacon 210 of the tag 115-b, and/or preparing and/or transmitting a tag indication 260.

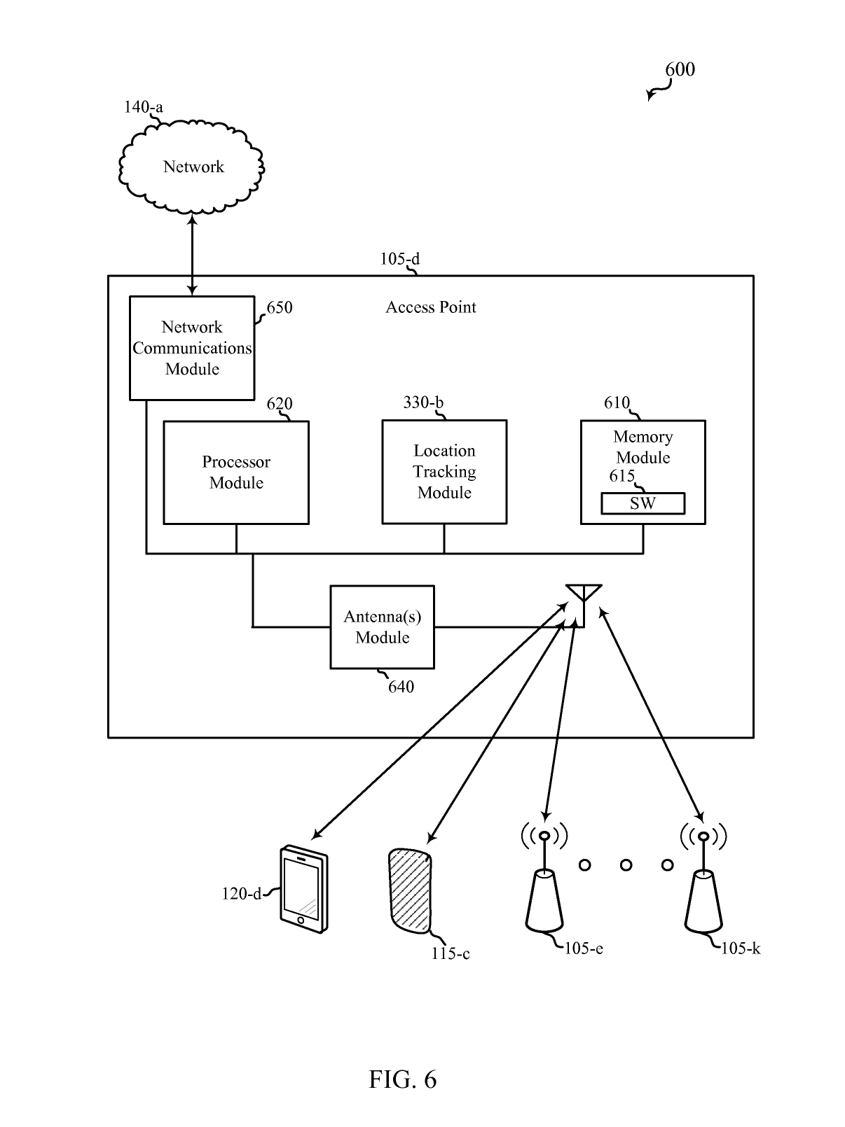

FIG. 6 depicts a block diagram of a system 600 configured for wirelessly searching in a location tracking environment in accordance with various embodiments. The system 600 may include APs 105-d, 105-e, and 105-k, which may be examples of the APs 105 described with reference to one or more of FIGS. 1, 2, 3A and 3B. The AP 105-d may include a memory module 610, which, in some embodiments, includes a software module 615. The AP 105-d may include a processor module 620, antenna(s) module 640, a network communications module 650, and/or a location tracking module 330-b. Each of the components of the AP 105-d may be in communication with each other. The network communications module 650 may be in communication with the network 140-a, which may be an example of the network 140 of FIG. 1.

The memory module 610 may include random access memory (RAM) and read-only memory (ROM). In some embodiments, the memory module 610 also stores computer-readable, computer executable software (SW) code 615 containing instructions configured to, when executed, cause the processor module 620 to perform various functions described herein related to wirelessly searching in a location tracking environment. In other embodiments, the software (SW) code 615 may not be directly executable by the processor module 620; but it may be configured to cause a computer, e.g., when compiled and executed, to perform the functions described herein.

The processor module 620 may include an intelligent hardware device, such as a central processing unit (CPU). The processor module 620 may perform various operations associated with wirelessly searching in a location tracking environment. The processor module 620 may use scheduling information received from, for example, the tracking management server 150, by way of the network 140-a, to determine when it is desirable to update tag 115 locations.

Some embodiments of the AP 105-d include a single antenna; other embodiments include multiple antennas. As shown in FIG. 6, signals transmitted from a tag 115-c and/or mobile device 120-d may be transmitted to and/or received by the AP 105-d via the antenna(s) in or connected to the antenna(s) module 640. The AP 105-d may also wirelessly communicate with other APs, such as APs 105-e through 105-k. In some embodiments, the AP 105-d may receive signals and use the received signals for determining a location (e.g., a position) of a tag unit 115. In some cases, the AP 105-d may transmit received signals to the tracking management server 150 via the network communications module 650 and the network 140-a. The system 600 may include a location tracking module 330-b, which may be an example of a location tracking module 330 of FIG. 3A, a location tracking module 330-a of FIG. 3B, or both.

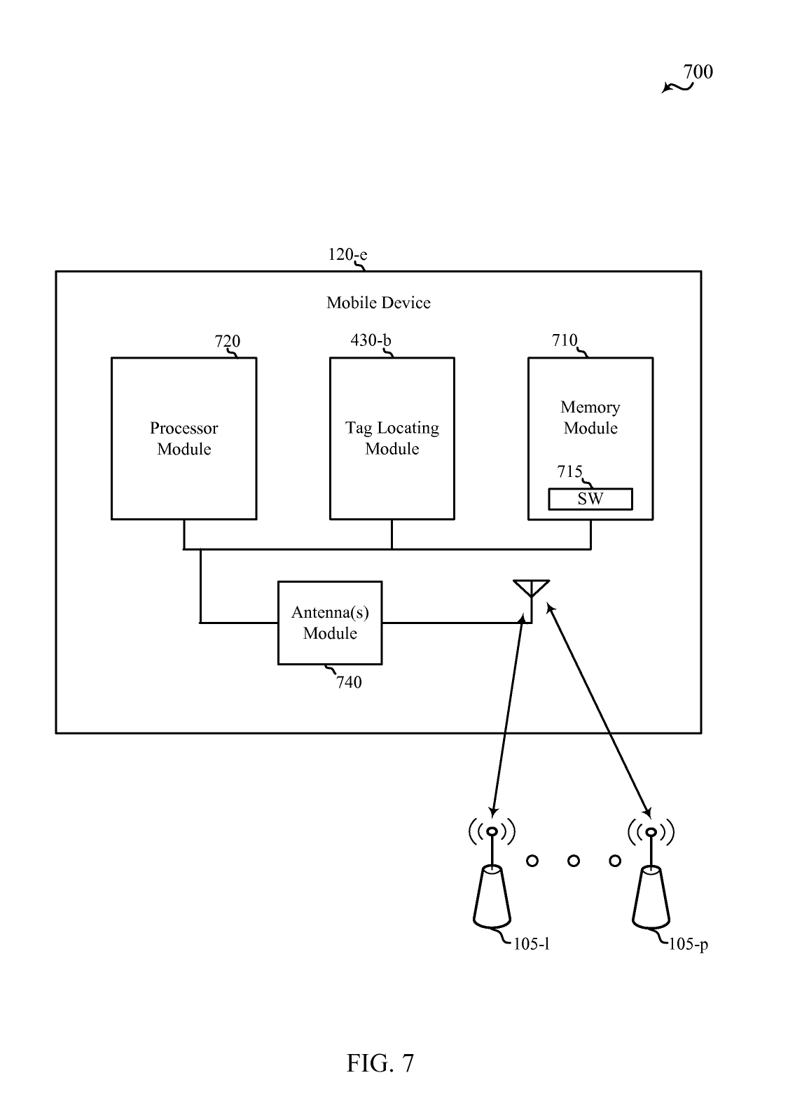

FIG. 7 shows a block diagram illustrating a system 700 configured for wirelessly searching in a location tracking environment in accordance with various embodiments, which may include a mobile device 120-e. In some embodiments, the mobile device 120-e includes one or more aspects of the mobile devices 120 of any or all of FIGS. 1, 2, 4A, 4B, and 6. The mobile device 120-e may include a processor module 720, a memory module 710, a tag locating module 430-b, and antenna(s) module 740.

The memory module 710 may include random access memory (RAM) or read-only memory (ROM), or both. In some embodiments, the memory module 710 stores computer-readable, computer-executable software (SW) code 715 containing instructions that are configurable to, when executed, cause the processor module 720 to perform various functions described herein for controlling the mobile device 120-e. In other embodiments, the software code 715 is not directly executable by the processor module 720, but it may be configured to cause a computer, for example, when compiled and executed, to perform functions described herein.

The system 700 may include a transceiver module (not shown), which may include a modem configured to modulate packets and provide the modulated packets to the antenna(s) module 740 for transmission, and to demodulate packets received from the antenna(s) module 740. The transceiver module(s) may, in some examples, be implemented as one or more transmitter modules and one or more separate receiver modules. The transceiver module(s) may support discovery-related communications. FIG. 7 shows broadcast and reception of signals between the mobile device 120-e and several APs 105-1 through 105-p. In the system 700, at least two APs 105-1 and 105-p are shown communicating with the mobile device 120-e; but the mobile device 120-e may communicate with more or fewer APs 105. The system 700 may include a tag locating module 430-b, which may be an example of a tag locating module 430 of FIG. 4A, a tag locating module 430-a of FIG. 4B, or both.

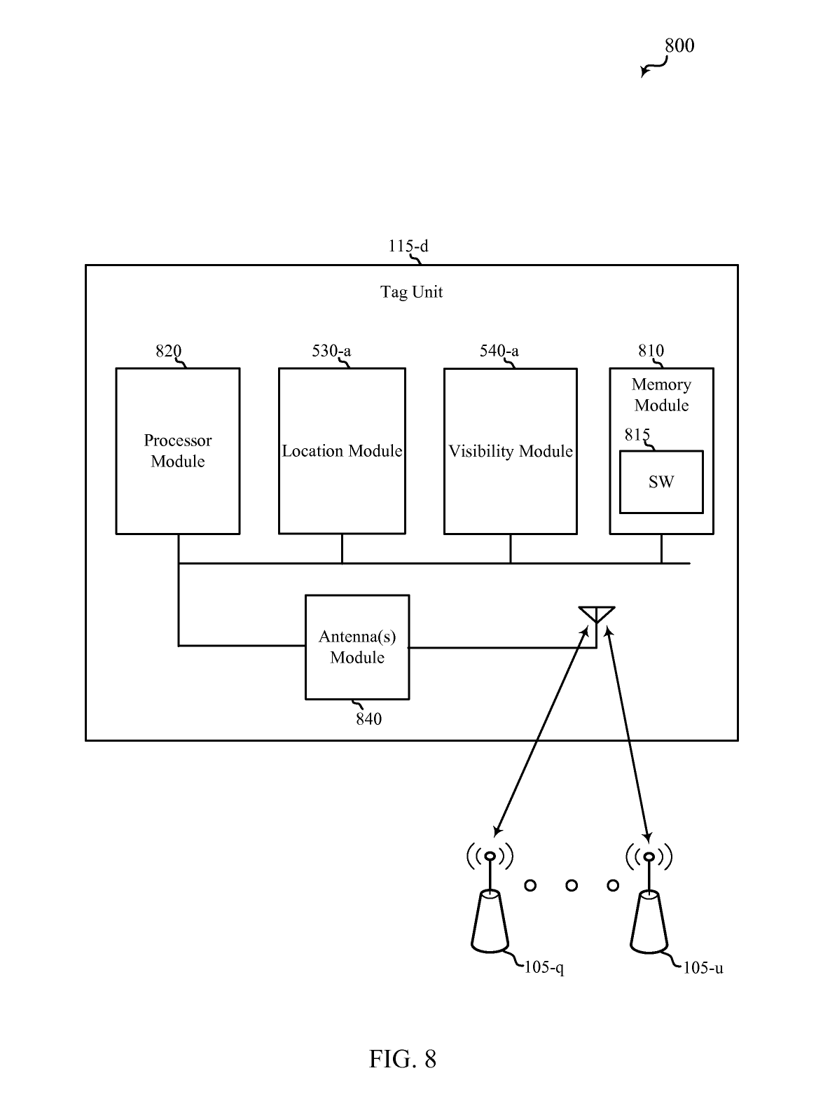

FIG. 8 shows a block diagram illustrating a system 800 configured for wirelessly searching in a location tracking environment in accordance with various embodiments, which may include a tag unit 115-d. In some embodiments, the tag unit 115-d includes one or more aspects of the tag units 115 of any or all of FIGS. 1, 2, 5, and 6. The tag unit 115-d may include a processor module 820, a memory module 810, a location module 530-a, a visibility module 540-a, and antenna(s) module 840.

The memory module 810 may include random access memory (RAM) or read-only memory (ROM), or both. In some embodiments, the memory module 810 stores computer-readable, computer-executable software (SW) code 815 containing instructions that are configurable to, when executed, cause the processor module 820 to perform various functions described herein for controlling the tag unit 115-d. In other embodiments, the software code 815 is not directly executable by the processor module 820, but it may be configured to cause a computer, for example, when compiled and executed, to perform functions described herein.

The system 800 may include an UWB transmitter module (not shown) which may support radio frequency (RF) communication technology to broadcast UWB signals through the antenna(s) module 840. Likewise, the system 800 may include a narrowband transceiver module (not shown) which may support RF communication technology to broadcast narrowband signals through the antenna(s) module 840. The UWB transmitter module or the narrowband transceiver module, or both, may include a modulator (not shown) to modulate location tracking information and provide the modulated information to the antenna(s) module 840 for transmission of signals.

The narrowband transceiver module may include an integrated processor. It may also include a timer. The narrowband transceiver module may be capable of communicating with wireless local area network (WLAN) products that are based on the IEEE 802.11 family of standards (WiFi). In some embodiments, the narrowband transceiver module is a two-way digital radio based on the IEEE 802.15 family of standards (ZigBee).

The system 800 may also include an oscillator (not shown), which may be connected to the UWB transmitter module. The UWB transmitter module may include a UWB modulator and a radio frequency (RF) transmitter. In some embodiments, the UWB transmitter module includes, or is in communication with, a timer. In some cases, the narrowband transceiver module and the UWB transmitter module operate according to a 32 MHz timer.

FIG. 8 shows broadcast and reception of signals between the tag unit 115-d and several APs 105-q through 105-u. In the system 800, at least two APs 105-q and 105-u are shown communicating with the tag 115-d; but the tag 115-d may communicate with more or fewer APs 105. The system 800 may include a location module 530-a, which may be an example of a location module 530 of FIG. 5. The system 800 may include a visibility module 540-a, which may be an example of a visibility module 540 of FIG. 5.

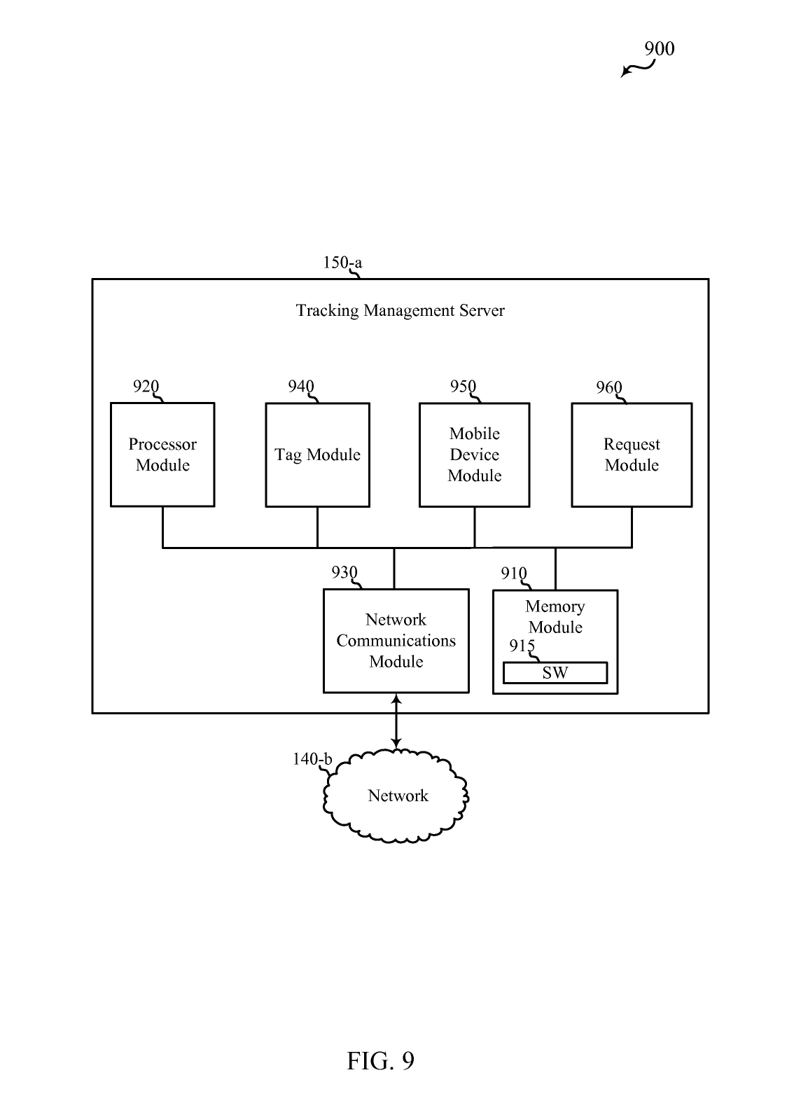

Referring next to FIG. 9, a system 900 is illustrated with a block diagram. The system 900 may be configured for wirelessly searching in a location tracking environment in accordance with various embodiments. In some embodiments, the system 900 includes a tracking management server 150-a, which may be the tracking management server 150 of FIG. 1. The tacking management server 150-a may include a processor module 920, a memory module 910, a network communications module 930, a tag module 940, a mobile device module 950, and/or a request module 960.

The processor module 920 may also perform various operations and may include an intelligent hardware device, e.g., a CPU. In some embodiments, the processor module 920 performs various operations associated with wirelessly searching in a location tracking environment. The tracking management server 150-a also may communicate with a network 140-b through the network communications module 930 to receive information from the APs 105 and/or to send information to the APs 105. The network 140-b may be an example of the networks 140 of either or both of FIGS. 1 and 6.

The memory module 910 may include RAM and/or ROM. In some embodiments, the memory module 910 stores computer-readable, computer-executable software code 915 containing instructions that are configured to, when executed, cause the processor module 920 to perform various functions described herein. In other embodiments, the software code 915 may not be directly executable by the processor module 920; but the software code module may be configured to cause a computer, e.g., when compiled and executed, to perform functions described herein. The memory module 910 may include a database to store a list of information relating to tags 115, mobile devices 120, APs 105, users, requests, and/or locations.

The tag module 940, may perform various operations and may include an intelligent hardware device, e.g., a CPU. In some embodiments, the tag module 940 includes one or more aspects of the tag module 340 of FIG. 3B. The mobile device module 950, may perform various operations and may include an intelligent hardware device, e.g., a CPU. In some embodiments, the mobile device module 950 includes one or more aspects of the mobile device module 350 of FIG. 3B. The request module 960, may perform various operations and may include an intelligent hardware device, e.g., a CPU. In some embodiments, the request module 960 includes one or more aspects of the request module 360 of FIG. 3B.

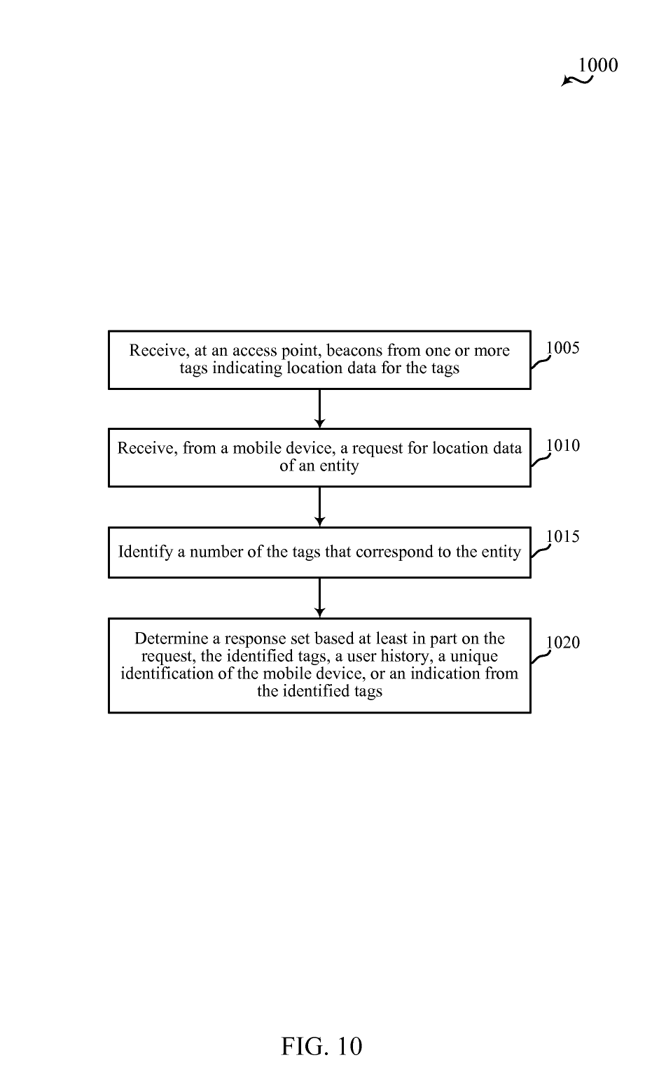

FIG. 10 shows a flow diagram that illustrates a method 1000 for wirelessly searching in a location tracking environment in accordance with various embodiments. The method 1000 may be implemented using, for example, the devices, systems, and call flow(s) 100, 200, 300, 300-a, 400, 400-a, 500, 600, 700, 800, and 900 of FIGS. 1, 2, 3A, 3B, 4A, 4B, 5, 6, 7, 8, and 9.

At block 1005, an AP 105, tracking management server 150, and/or some other network component may receive beacons from one or more tags 115 indicating location data for the tags 115. In some embodiments, the operations at block 1005 are performed by the location tracking module 330 of FIG. 3A; the tag module 340 of FIG. 3B; the device 600 of FIG. 6; and/or the device 900 of FIG. 9.

At block 1010, an AP 105, tracking management server 150, and/or some other network component may receive, from a mobile device 120, a request for location data of an entity. For example, the operations at block 1010 may be performed by: the location tracking module 330 of FIG. 3A; the mobile device module 350 of FIG. 3B; the request module 360 of FIG. 3B; the device 600 of FIG. 6; and/or the device 900 of FIG. 9.

At block 1015, an AP 105, tracking management server 150, and/or some other network component may identify a number of the tags that correspond to the entity. For example, the operations at block 1015 may be performed by: the location tracking module 330 of FIG. 3A; the tag module 340 of FIG. 3B; the request module 360 of FIG. 3B; the device 600 of FIG. 6; and/or the device 900 of FIG. 9.

At block 1020, an AP 105, tracking management server 150, and/or some other network component may determine a response set based at least in part on the request, the identified tags, a user history, a unique identification of the mobile device, or an indication from the identified tags. In some cases, the operations at block 1020 are performed by: the location tracking module 330 of FIG. 3A; the mobile device module 350 of FIG. 3B; the request module 360 of FIG. 3B; the device 600 of FIG. 6; and/or the device 900 of FIG. 9.

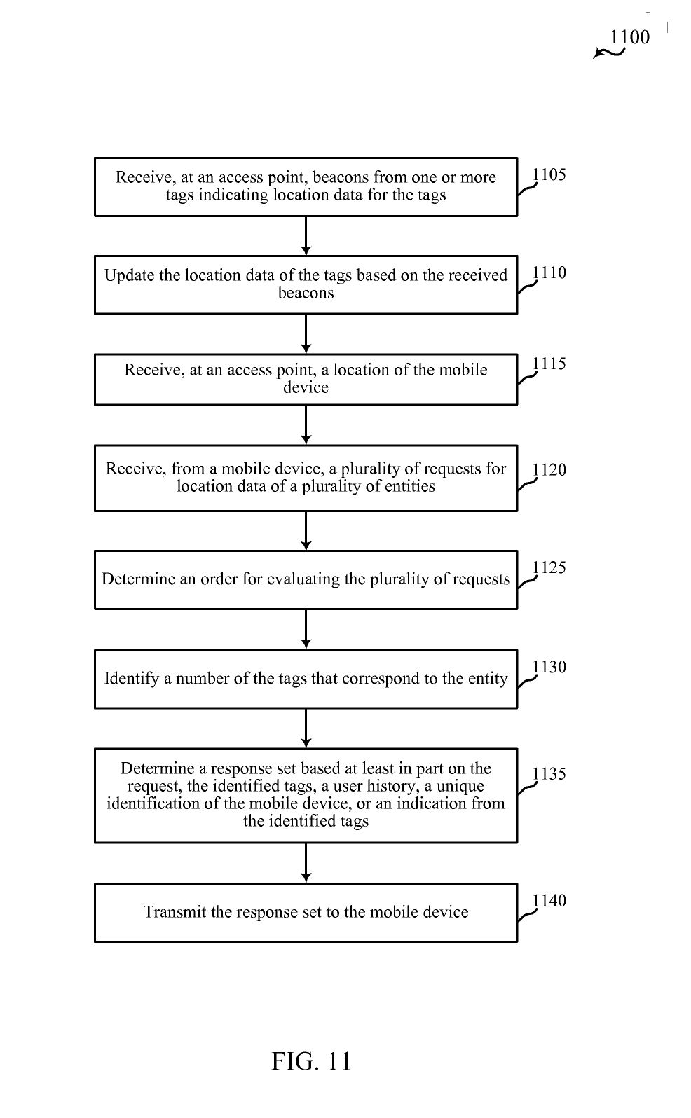

FIG. 11 shows a flow diagram that illustrates a method 1100 for wirelessly searching in a location tracking environment in accordance with various embodiments. The method 1100 may be implemented using, for example, the devices, systems, and call flow(s) 100, 200, 300, 300-a, 400, 400-a, 500, 600, 700, 800, and 900 of FIGS. 1, 2, 3A, 3B, 4A, 4B, 5, 6, 7, 8, and 9.

At block 1105, an AP 105, tracking management server 150, and/or some other network component may receive beacons from one or more tags 115 indicating location data for the tags 115. In some embodiments, the operations at block 1105 are performed by the location tracking module 330 of FIG. 3A; the tag module 340 of FIG. 3B; the device 600 of FIG. 6; and/or the device 900 of FIG. 9.

At block 1110, an AP 105, tracking management server 150, and/or some other network component may update the location data of the tags 115 based on the received beacons. For example, the operations at block 1110 may be performed by: the location tracking module 330 of FIG. 3A; the tag module 340 of FIG. 3B; the device 600 of FIG. 6; and/or the device 900 of FIG. 9.

At block 1115, an AP 105, tracking management server 150, and/or some other network component may receive a location of the mobile device 120. For example, the operations at block 1115 may be performed by: the location tracking module 330 of FIG. 3A; the mobile device module 350 of FIG. 3B; the device 600 of FIG. 6; and/or the device 900 of FIG. 9.

At block 1120, an AP 105, tracking management server 150, and/or some other network component may receive, from a mobile device 120, a plurality of requests for location data of a plurality of entities. For example, the operations at block 1120 may be performed by: the location tracking module 330 of FIG. 3A; the mobile device module 350 of FIG. 3B; the request module 360 of FIG. 3B; the device 600 of FIG. 6; and/or the device 900 of FIG. 9.

At block 1125, an AP 105, tracking management server 150, and/or some other network component may determine an order for evaluating the plurality of requests. For example, the operations at block 1125 may be performed by: the location tracking module 330 of FIG. 3A; the request module 360 of FIG. 3B; the device 600 of FIG. 6; and/or the device 900 of FIG. 9.

At block 1130, an AP 105, tracking management server 150, and/or some other network component may identify a number of the tags 115 that correspond to the entity. For example, the operations at block 1130 may be performed by: the location tracking module 330 of FIG. 3A; the tag module 340 of FIG. 3B; the request module 360 of FIG. 3B; the device 600 of FIG. 6; and/or the device 900 of FIG. 9.

At block 1135, an AP 105, tracking management server 150, and/or some other network component may determine a response set based at least in part on the request, the identified tags, a user history, a unique identification of the mobile device, or an indication from the identified tags. In some cases, the operations at block 1135 are performed by: the location tracking module 330 of FIG. 3A; the mobile device module 350 of FIG. 3B; the request module 360 of FIG. 3B; the device 600 of FIG. 6; and/or the device 900 of FIG. 9.

At block 1140, an AP 105, tracking management server 150, and/or some other network component may transmit the response set to the mobile device 120. In some cases, the operations at block 1135 are performed by: the location tracking module 330 of FIG. 3A; the mobile device module 350 of FIG. 3B; the request module 360 of FIG. 3B; the device 600 of FIG. 6; and/or the device 900 of FIG. 9.

It will be apparent to those skilled in the art that the methods 1000 and 1100 are but example implementations of the tools and techniques described herein. The methods 1000 and 1100 may be rearranged or otherwise modified such that other implementations are possible.

The detailed description set forth above in connection with the appended drawings describes example embodiments and does not represent the only embodiments that may be implemented or that are within the scope of the claims. The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

What is claimed is:

1. A method for wirelessly searching an environment, comprising:
receiving, at an access point, beacons from one or more tags indicating location data for the tags;
receiving, from a mobile device, a request for location data of an entity; and
identifying a number of the tags that correspond to the entity.

2. The method of claim 1, further comprising:
determining a response set based at least in part on the request, the identified tags, a user history, a unique identification of the mobile device, or an indication from the identified tags.

3. The method of claim 2, further comprising:
transmitting the response set to the mobile device.

4. The method of claim 2, wherein the response set comprises location data of the identified tags.

5. The method of claim 4, further comprising:
receiving, at an access point, a location of the mobile device.

6. The method of claim 5, wherein the location data of the identified tags comprises a relative location with respect to the location of the mobile device.

7. The method of claim 4, wherein the location data of the identified tags comprises a predicted location.

8. The method of claim 2, wherein the response set comprises a no-match indicator, the no-match indicator comprising at least one of a null response, a null value, an autonomous determination response, or a clarifying prompt.

9. The method of claim 2, wherein the response set comprises data for a second entity, the second entity being different from the entity for which location data was requested.

10. The method of claim 1, further comprising:
updating the location data of the tags based on the received beacons.

11. The method of claim 1, wherein receiving the request comprises:
receiving, from the mobile device, a plurality of requests for location data of a plurality of entities; and
determining an order for evaluating the plurality of requests.

12. The method of claim 11, wherein determining the order for evaluating the plurality of requests is based on at least one of a proximity decision, a category decision, a sponsor decision, an advertisement decision, an availability decision, a route decision, a user history decision, an autonomous decision, or a sale decision.

13. The method of claim 1, wherein receiving the request comprises:
receiving, from the mobile device, a category request for location data of the entity.

14. A system for wirelessly searching an environment, comprising:
means for receiving, at an access point, beacons from one or more tags indicating location data for the tags;
means for receiving, from a mobile device, a request for location data of an entity; and
means for identifying a number of the tags that correspond to the entity.

15. The system of claim 14, further comprising:
means for determining a response set based at least in part on the request, the identified tags, a user history, a unique identification of the mobile device, or an indication from the identified tags.

16. The system of claim 15, further comprising:
means for transmitting the response set to the mobile device.

17. The system of claim 15, wherein the response set comprises location data of the identified tags.

18. The system of claim 17, further comprising:
means for receiving, at an access point, a location of the mobile device.

19. The system of claim 18, wherein the location data of the identified tags comprises a relative location with respect to the location of the mobile device.

20. The system of claim 17, wherein the location data of the identified tags comprises a predicted location.

21. The system of claim 15, wherein the response set comprises a no-match indicator, the no-match indicator comprising at least one of a null response, a null value, an autonomous determination response, or a clarifying prompt.

22. The system of claim 15, wherein the response set comprises data for a second entity, the second entity being different from the entity for which location data was requested.

23. The system of claim 14, further comprising:
means for updating the location data of the tags based on the received beacons.

24. The system of claim 14, wherein the means for receiving the request comprises:
means for receiving, from a mobile device, a plurality of requests for location data of a plurality of entities; and
means for determining an order for evaluating the plurality of requests.

25. The system of claim 24, wherein determining the order for evaluating the plurality of requests is based on at least one of a proximity decision, a category decision, a sponsor decision, an advertisement decision, an availability decision, a route decision, a user history decision, an autonomous decision, or a sale decision.

26. The system of claim 14, wherein the means for receiving the request comprises:
means for receiving, from a mobile device, a category request for location data of the entity.

27. An apparatus for wirelessly searching an environment, comprising:
a processor;
memory in electronic communication with the processor; and
instructions stored in the memory, the instructions being executable by the processor to:
receive, at an access point, beacons from one or more tags indicating location data for the tags;
receive, from a mobile device, a request for location data of an entity; and
identify a number of the tags that correspond to the entity.

28. The apparatus of claim 27, wherein the instructions are further executable by the processor to:
determine a response set based at least in part on the request, the identified tags, a user history, a unique identification of the mobile device, or an indication from the identified tags.

29. The apparatus of claim 28, wherein the instructions are further executable by the processor to:
transmit the response set to the mobile device.

30. A computer-program product for wireless searching an environment, the computer-program product comprising a non-transitory computer-readable medium storing instructions executable by a processor to:
receive, at an access point, beacons from one or more tags indicating location data for the tags;
receive, from a mobile device, a request for location data of an entity; and
identify a number of the tags that correspond to the entity.
